(19) United States
(12) Patent Application Publication
(10) Pub. No.: US 2003/0037868 A1
(43) Pub. Date: Feb. 27, 2003

(54) Method and apparatus for applying designs to surfaces

(76) Inventor: Lori D. Casciani, Westlake, OH (US)

Correspondence Address: James E. Scarbrough, FAY, SHARPE, FAGAN, MINNICH & McKEE, LLP, 7th Floor, 1100 Superior Avenue, Cleveland, OH, 44114-2518, US

(21) Appl. No.: 10/274,319

(22) Filed: Oct. 18, 2002

Related U.S. Application Data
(62) Division of application No. 09/656,630, filed on Sep. 7, 2000, now abandoned.
(60) Provisional application No. 60/153,111, filed on Sep. 7, 1999.

(51) Int. Cl. B32B 31/00

(52) U.S. Cl. 156/249; 118/504

(57) ABSTRACT

A tape includes the single sheet having a top side and a bottom side. The single sheet is rolled onto a cylinder. The cylinder is a cardboard or similar material cylinder. The sheet is comprised of a material that does not allow paint to seep through the sheet and apply to the surface. At least one cut extends through the sheet from the top side to the bottom side. The cuts form at least one opening in the sheet. The openings form decorative designs. The designs are evenly spaced longitudinally along the sheet to form a pattern. The bottom side has an adhesive applied to the bottom side. The bottom side adheres to a portion of the top side which is located directly underneath the bottom side when the tape is rolled on the cylinder. When the sheet is removed from the cylinder, the bottom side is removed from contact with the top side and is applied directly onto an application surface.

This application claims priority from U.S. Provisional Application Serial No. 60/153,111, filed on Sep. 7, 1999.

### FIELD OF THE INVENTION

This invention relates to an apparatus and a method for applying decorative designs to surfaces such as interior and exterior walls, ceilings, furniture and miscellaneous other domestic objects. More particularly, it relates to tape which is perforated with cut-out designs which is applied to a surface to be painted.

### BACKGROUND OF THE INVENTION

Home decorating continues to have a widespread acceptance as an enjoyable form of recreation, as a way of saving money in home improvements and as a way to make a home a more beautiful place in which to live. People decorating their homes or rooms range in age from children in grade school to the elderly. Room walls and ceilings are a favorite area to decorate with posters, hangings and decorative designs by means of a stencil.

Some of the problems encountered with the existing prior art stencils leads to the conclusion that the ideal wall or ceiling stencil should be of one piece construction, should adhere totally to the surface to be decorated, and should easily peel from the surface leaving no residue and removing no previously applied paint. Unfortunately, none of the prior art devices possess all of these attributes.

In the prior art, stencils have been made from multiple layers requiring the removal of one of the layers prior to adhering the stencil to the surface to be painted. Other stencils had to be held in place using masking tape or by hand.

Accordingly, it has been considered desirable to develop a new and improved method and apparatus for applying a decorative design to a surface which would overcome the foregoing difficulties and others and meet the above-stated needs while providing better and more advantageous overall results.

### BRIEF SUMMARY OF THE INVENTION

The present invention relates to a method and apparatus for applying a decorative design to a surface.

More particularly, a tape is made of various types of adhesives that can be applied to any surface and is easily removed without damage or removal of previously applied paint and texture. The main use of this border tape is to easily apply paint to wall surfaces to create a design. The tape could also be used to decorate other types of surfaces such as lamps, floors, pottery and wood.

The tape is perforated with different types of designs. The design cut-outs are spaced along the length of the tape. As the tape is removed from a roll, the tape is applied to a surface to be painted. The design-shaped openings expose a portion of the surface to be painted. The surrounding portions of the surface is covered by the tape. An application of paint is then applied to design cut-out area. The paint can be applied by using a brush, towel, sponge or any product used to apply paint. Various designs may be applied to one area. The tape is then removed from the surface, exposing the painted designs.

Specifically, the tape is comprised of a single sheet having a top side and a bottom side. The single sheet is rolled onto a cylinder. The cylinder can be a cardboard or similar material cylinder. The sheet is comprised of a material that does not allow paint to seep through the sheet and apply to the surface. At least one cut extends through the sheet from the top side to the bottom side. The cut forms at least one opening in the sheet. The openings form decorative designs. The designs are evenly spaced longitudinally along the sheet to form a pattern. The bottom side has an adhesive applied to it.

The bottom side adheres to a portion of the top side which is located directly underneath the bottom side when the tape is rolled on the cylinder. When the sheet is removed from the cylinder, the bottom side is removed from contact with the top side and is applied directly onto an application surface.

One advantage of the present invention is the provision of an inexpensive, easy-to-use method of applying multiple designs to surfaces.

Another advantage of the present invention is the provision of eliminating a stencil, thus eliminating outline drawings which are required when stenciling and measurements which are required each time the stencil is used.

Still another advantage is the provision of tape which will outline the area that is being painted so that paint can be applied more freely without worry of making errors.

Yet another advantage of the present invention is the provision of tape can be applied in various directions (horizontal, diagonal, and vertical).

Yet still another advantage of the present invention is the provision of two tape rolls of different widths which may be used next to each other to create a large design or split design.

Still other benefits and advantages of the present invention will become apparent to those skilled in the art upon a reading and understanding of the following detailed specification.

### BRIEF DESCRIPTION OF THE DRAWINGS

The invention may take form in certain parts and arrangements of parts, a preferred embodiment of which will be described in detail in this specification and illustrated in the accompanying drawings which form a part hereof and wherein:

FIG. 1 is a perspective view of a roll of tape with cut-out designs in accordance with the preferred embodiment of the present invention.

FIG. 2 shows a perspective view of the tape of FIG. 1 showing the tape partially peeled from the roll.

FIG. 3 shows an elevational view of the tape being applied to a surface, exposing the painted designs.

### DETAILED DESCRIPTION OF THE PREFERRED EMBODIMENTS

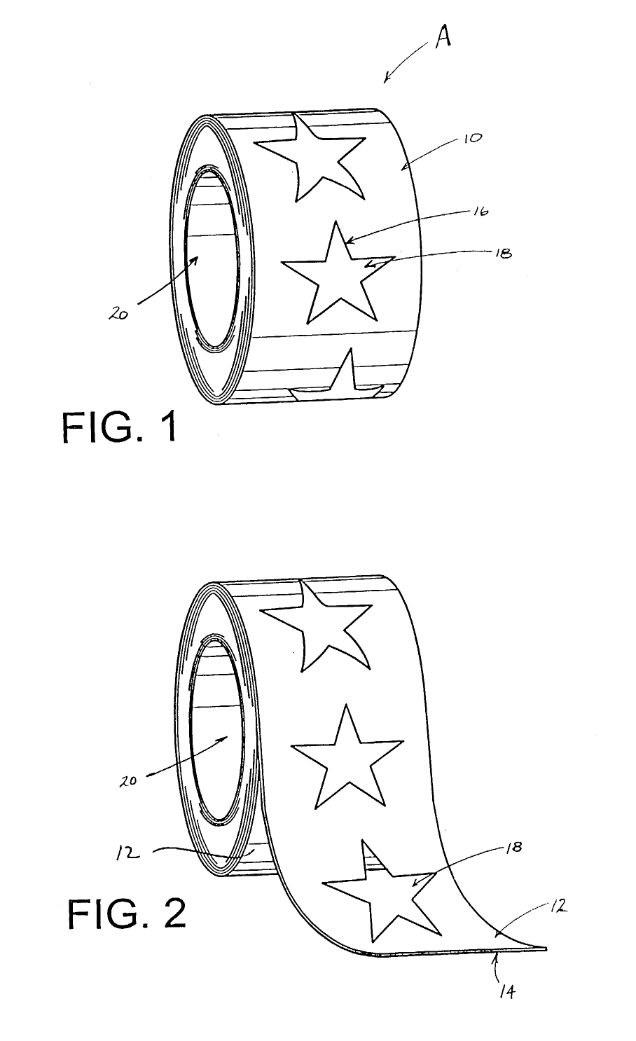

Referring to the drawings, wherein the showings are for purposes of illustrating preferred embodiments of this invention only, and not for purposes of limiting same, FIG. 1 shows a perspective view of a roll of tape with cut-out designs in accordance with the preferred embodiment of the present invention. FIG. 1 and FIG. 2 show a tape A rolled onto a roll or cylinder 20. The tape A is made from a material that is impermeable to paint. For example, the tape can be made from a cellulose-based paper. The cylinder 20 can be made of cardboard or another similar material.

The tape A is comprised of a single sheet 10, the sheet 10 having a top side 12 and a bottom side 14. The sheet 10 can be of variable length and width. The bottom side 14 of the sheet has an adhesive coating which allows the tape to stick to the surface to be painted. The adhesive applied to the bottom side 14 of the sheet 10 is made from material that will leave no noticeable residue on the surface after the sheet 10 is peeled from the surface after painting. The adhesive should also not peel any previously applied paint from the surface when it is peeled from the surface.

When the tape is in the rolled configuration on the roll, the bottom side 14 adheres to a portion of the top side 12 which is located directly underneath the bottom side 14. The tape then is secured in a rolled fashion by the bottom side 14 being in contact with and adhering to the top side 12. As the tape is unwound from the roll, the bottom side 14 is brought out of contact with top side 12 located underneath the bottom side. The bottom side 14 is then directly placed into contact with the application surface.

The tape A also contains cuts 16 in the sheet 10 that extend through the sheet 10 from the top side 12 through to the bottom side 14. The cuts 16 may form design cut-outs or openings 18 in the tape A. In the preferred embodiment, design cut-outs 18 are evenly spaced longitudinally along the sheet 10 to form a pattern. The design cut-outs 18 are cut out of the sheet 10 so that an adequate amount of the sheet still surrounds the design cut-outs 18. The person applying paint to the sheet 10 and the surface to be painted will then not have to be extremely careful when applying paint so that no paint will accidentally get on the surface by spilling over the edges of the sheet 10.

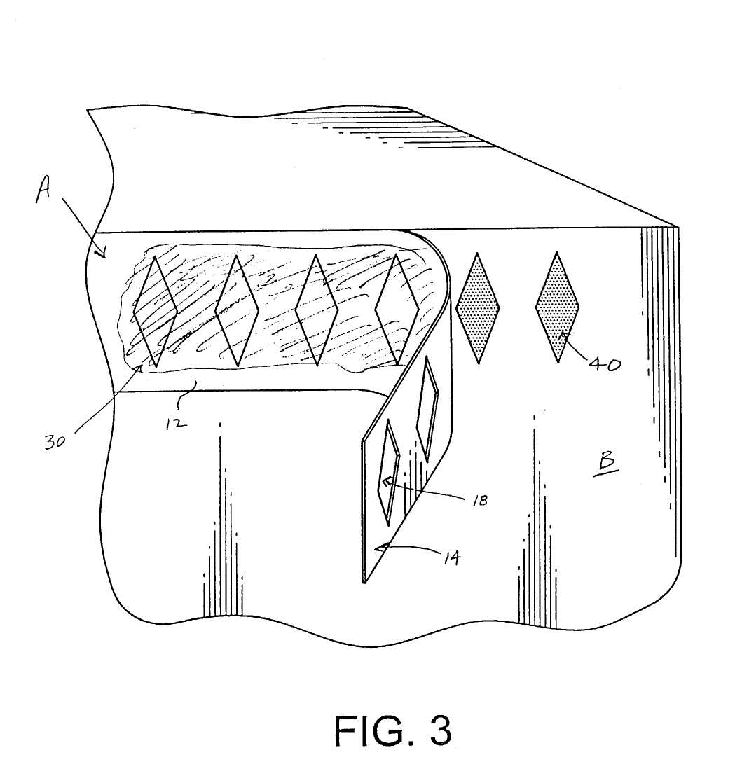

FIGS. 1 and 2 illustrate the design cut-outs 18 to be in the shape of stars. However, many other designs can be used, including diamonds (as seen in FIG. 3), hearts, names, four-leaf clovers, flowers, etc.

FIG. 3 illustrates applying designs to a surface B using the tape A. The surface B shown in FIG. 3 is a flat wall, however the tape would work easily as well on curved walls, floors, picture frames, furniture and other items. First, the sheet 10 is peeled from the cylinder 20 by pulling the bottom side 14 from contact with the top side 12. Then the tape A is placed on the surface wall B by placing the bottom side 14 into direct contact with the wall surface. The tape A can be applied horizontally, vertically or diagonally to the wall B. Two tapes, which can be of different widths, can also be applied side-by-side to offer greater flexibility in design width. The adhesive of bottom side 14 secures the tape to the wall. The design cut-outs 18 leave a portion of the wall B exposed.

Paint 30, or other similar material such as stain, is applied to the tape A and wall B to be painted. The paint 30 can be applied using a brush, roller, or in any other manner in which paint is commonly applied. As seen in FIG. 3, a portion of the paint 30 overlaps the design cut-outs 18 and remains on the tape top side 12. The paint 30 is then allowed to dry. The tape A is then removed or peeled from the wall B after the paint has dried leaving designs 40 shaped like the design cut-outs 18, on the wall B.

The adhesive of the tape will not leave a residue on the wall, and none of the paint applied to the top side of the tape will remain on the wall. Only the paint forming the design that was applied directly to the wall through the design openings will remain on the wall. The tape can then be discarded upon removal from the wall. There is no cleanup or mess remaining after the tape is removed.

Due to the flexible nature of the tape, it can conform to many different surfaces, including flat walls, rounded or angled walls, various contours of furniture, lamps, etc.

The invention has been described with reference to a preferred embodiment. Obviously, alterations and modifications will occur to others upon a reading and understanding of this specification. It is intended to include all such modifications and alternations insofar as they come within the scope of the appended claims or the equivalents thereof.

Having thus described the preferred embodiment, the invention is now claimed:

1. A tape comprised of:
a single sheet having a top side and a bottom side, said single sheet being rolled onto a cylinder;
at least one cut extending through the sheet from the top side to the bottom side, wherein said at least one cut forms at least one opening in the sheet;
wherein the bottom side has an adhesive applied to the bottom side.

2. The tape of claim 1, wherein said cylinder is a cardboard or similar material cylinder.

3. The tape of claim 1, wherein the sheet is comprised of a material that does not allow paint to seep through the sheet and apply to the surface.

4. The tape of claim 1, wherein said at least one opening forms decorative designs.

5. The tape of claim 4, wherein said designs are evenly spaced longitudinally along the sheet to form a pattern.

6. The tape of claim 1, wherein said bottom side adheres to a portion of the top side which is located directly underneath the bottom side when the tape is rolled on the cylinder.

7. The tape of claim 6, wherein when the sheet is removed from the cylinder, the bottom side is removed from contact with the top side and is applied directly onto an application surface.

8. A method of applying designs to a surface comprising:
unrolling a sheet with at least one opening from a roll by separating an adhesive side of the sheet from a non-adhesive side of the sheet;
applying the adhesive side directly onto an application surface;
applying paint to the non-adhesive side and the application surface through the at least one opening; and
removing the sheet from the surface allowing the paint to remain on the surface.

9. The method of claim 8, further comprising the step of cutting the at least one opening in the sheet in the form of a design prior to applying-the sheet to the application surface.

10. A tape comprised of:
a single sheet having a top side and a bottom side, wherein the bottom side of the sheet contains an adhesive applied to it, and
cuts extending through the sheet, wherein the cuts form openings in the sheet, said openings form designs which are evenly spaced longitudinally along the sheet to form a pattern.

11. The tape of claim 10, wherein the sheet may be rolled onto a cylinder.

12. The tape of claim 11, wherein the cylinder is comprised of cardboard or similar material.

13. The tape of claim 10, wherein the sheet is comprised of a material that does not allow paint to seep through the sheet and apply to the surface.

14. The tape of claim 11, wherein said bottom side adheres to a portion of the top side which is located directly underneath the bottom side when the tape is rolled on the cylinder.

15. The tape of claim 14, wherein the bottom side is removed from contacting the top side and is applied directly onto an application surface.

16. A tape comprised of:
a single sheet having a top side and a bottom side rolled onto a cylinder, wherein the bottom side of the sheet contains an adhesive applied to it, said bottom side is removably secured to a portion of the top side which is positioned directly underneath the bottom side when the sheet is rolled on the cylinder; and
cuts extending through the sheet, wherein the cuts form openings in the sheet, said openings form designs which are evenly spaced longitudinally along the sheet to form a pattern, wherein when said sheet is removed from said cylinder, said bottom side is placed directly onto an application surface.

17. The tape of claim 16, wherein said tape can conform to a curved application surface.
